(19) United States
(12) Patent Application Publication
(10) Pub. No.: US 2011/0149407 A1
(43) Pub. Date: Jun. 23, 2011

(54) RUGGED VARIABLE FOCUS LIQUID LENSES AND ACTUATORS FOR ACTUATION OF LIQUID LENSES

(75) Inventors: Saman Dharmatilleke, Singapore (SG); Aik Hau Khaw, Singapore (SG)

(73) Assignee: Agency for Science, Technology and Research, Connexis (SG)

(21) Appl. No.: 12/303,703

(22) PCT Filed: Jun. 8, 2006
(86) PCT No.: PCT/SG2006/000147

§ 371 Date: Dec. 23, 2009

(51) Int. Cl. G02B 3/14; B29D 11/00; G02B 3/12

(52) U.S. Cl. 359/666; 264/1.1; 359/665

(57) ABSTRACT

An optical device (100) includes a housing having a hydrophobic top surface (108), a bottom surface and a first cavity (104), wherein the cavity has inwardly curved walls. A first fluid (110) having a first meniscus is disposed within the first cavity. A first control means (112) is coupled with the first fluid for displacing fluid into and out of the first cavity.

### BACKGROUND OF THE INVENTION

The present invention relates generally to optical systems, and more particularly to rugged variable-focus liquid lenses.

In conventional optical imaging applications, such as optical communications systems and camera devices, manual tuning and physical positioning of a lens are typically required to focus an image onto a detector and to receive light from different directions relative to the lens. To eliminate the inefficiencies and expenses of manual tuning, tunable microlenses were developed to focus an optical signal by optimally coupling an optical source to an optical signal receiver, such as a photodetector. In some cases, the refractive index of the microlens is automatically varied to change the focus of the microlens when the incidence of a light beam upon the microlens varies from its nominal, aligned incidence, in order to maintain optimal coupling between the microlens and the photodetector.

However, tunable microlenses such as gradient index lenses have inherent limitations associated with the small electro-optic coefficients found in the majority of electro-optic materials used for such lenses. This often results in a small optical path modulation and thus requires thick lenses or high voltages. In addition, many electro-optic materials show strong birefringence causing polarization dependence of the microlens, which distorts light with certain polarization. These problems become especially severe in the case where arrays of tunable microlenses are required. For example, existing camera phones use tiny, fixed-focus lenses, which have poor light-gathering capabilities, limited focus range and limited resolution power. As a result, the image quality is low compared to conventional photo cameras.

Variable focus liquid lenses have been developed to overcome some of the above problems (see, e.g., U.S. Pat. No. 5,973,852). A variable focus fluid lens is provided when the focal length is controlled by changing the contact angle or radius of curvature of a fluid meniscus, which forms the optics of the lens. The optical device also typically includes a pressure or volume control means fluidly coupled with the fluid for adjusting the pressure of the fluid and therefore also the curvature of the meniscus.

However, improvements can be made for problems particular to liquid lenses, as opposed to rigid lenses. For example, the liquid lens may be disturbed after impact or rough handling. In such an event, liquid may separate from the lens and form droplets on the cover over the lens, altering the focus of the optical device. The droplets may become trapped on the cover and affect the performance of the device during its entire operation. Additionally, unlike a rigid lens, a liquid lens is also susceptible to detrimental impact when the device is not in use. Thus, to further minimize disturbances to the liquid lens, a mechanism to retract the liquid when it is not in use and to maintain the focus of the liquid lens when in use is desirable. Applications susceptible to shock and impact range widely from small, hand-held telecommunication devices such as mobile phone cameras, portable data storage devices such as CD/DVD drivers or barcode readers, analytic instruments such as microscopes and other detection devices, surgical instruments such as endoscopes, or various laser technology instruments.

Therefore, it is desirable to provide systems and methods that overcome the above and other problems. In particular, there is a need for a low cost and rugged optical focusing system with a recovery system for small, portable, imaging applications where rough handling is anticipated. What is desired is a recovery method that retracts liquid when not in use and that controls the focus of the liquid lens when in use. Embodiments of the invention provide for these and other needs.

### BRIEF SUMMARY OF THE INVENTION

The present invention provides rugged variable-focus lenses that overcome the above problems. In particular, the present invention provides systems and methods for efficiently forming liquid lenses and for recovering liquid lenses after shock-related events.

According to one embodiment of the invention, an optical device includes a housing having a hydrophobic top surface, a bottom surface and a first cavity, wherein the cavity has inwardly curved walls. A first fluid having a first meniscus is disposed within the first cavity. A first control means is coupled with the fluid for displacing fluid into and out of the first cavity. In one aspect, the hydrophobic top surface includes a layer of hydrophobic material covering a non-hydrophobic material. In another aspect, the walls are hydrophilic or include a layer of hydrophilic material covering a non-hydrophilic material.

According to another embodiment of the invention, an optical device includes a housing having a top surface, a bottom surface and a first cavity. The optical device also includes an air reservoir for holding compressed air or a gas. A fluid having a meniscus is disposed within the first cavity. A layer of hydrophobic material covers the top surface. A layer of hydrophilic material covers the walls of the first cavity. A control means is coupled with the fluid for displacing the first fluid into and out of the cavity.

According to another embodiment of the invention, a method for forming a liquid lens is provided. The method includes providing a fluid within a housing that includes a top surface, a bottom surface, and a cavity having inwardly curved walls, wherein the fluid forms a meniscus disposed within the cavity. In one aspect, a hydrophobic coating covers the top surface, and a hydrophilic coating covers the inwardly curved walls. The method also includes adjusting the curvature of the meniscus.

According to another embodiment of the invention, a method for retracting retracting a fluid in a liquid lens is provided. The method includes providing a fluid within a housing that includes a top surface, a bottom surface, and a cavity having inwardly curved walls, wherein the fluid forms a lens having a meniscus disposed within the cavity, and a hydrophobic coating covers the top surface. The method also includes retracting the fluid from the cavity.

According to another embodiment of the invention, an optical device includes a housing having a top surface, a bottom surface and a first cavity, wherein the cavity has inwardly curved walls. A first fluid having a meniscus is disposed within the first cavity, the first fluid forming a first liquid lens. A first control means is coupled with the first fluid for displacing fluid into and out of the first cavity. The optical device also includes a first non-liquid lens.

Reference to the remaining portions of the specification, including the drawings and claims, will realize other features and advantages of the present invention. Further features and advantages of the present invention, as well as the structure and operation of various embodiments of the present invention, are described in detail below with respect to the accompanying drawings. In the drawings, like reference numbers indicate identical or functionally similar elements.

### BRIEF DESCRIPTION OF THE DRAWINGS

FIG. 1A shows an isometric view of a liquid lens assembly with an inwardly curve cavity according to an embodiment of the invention.

FIG. 1B shows a side view of a liquid lens assembly with an inwardly curved cavity.

FIG. 1C shows a side view of a liquid lens assembly with an inwardly curved cavity before the liquid fills the inwardly curved cavity.

FIG. 1D shows a side view of a liquid lens assembly with an inwardly curved cavity after the liquid fills the inwardly curved cavity.

FIG. 1E shows a side view of nano- or micro-sized pillars formed on the top and bottom surfaces of an inwardly curved cavity to form hydrophobic surfaces.

FIG. 1F shows a side view of a nano- or micro-sized ridged topology on the top and bottom surfaces of an inwardly curved cavity to form hydrophilic surfaces.

FIG. 2A shows a top view of a flat cavity that is empty, according to an embodiment of the invention.

FIG. 2B shows a top view of a flat cavity with a liquid drop formed at the inlet.

FIG. 2C shows a top view of a flat cavity with a liquid drop enlarged at the inlet.

FIG. 2D shows a top view of a flat cavity with a liquid drop that has filled the cavity.

FIG. 3A shows a top view of an empty inwardly curved cavity according to an embodiment of the invention.

FIG. 3B shows a top view of an inwardly curved cavity with a liquid ring being formed.

FIG. 3C shows a top view of an inwardly curved cavity with the liquid ring merging.

FIG. 3D shows a top view of an inwardly curved cavity with a concave liquid lens formed.

FIG. 3E shows a top view of an inwardly curved cavity with a convex liquid lens formed.

FIG. 4A shows a side view of a liquid lens assembly with a housing for multiple lenses according to an embodiment of the invention.

FIG. 4B shows a side view of a liquid lens assembly with a liquid lens being formed.

FIG. 4C shows a side view of a liquid lens assembly with a liquid lens being adjusted.

FIG. 5A shows a side view of a liquid lens assembly with an enclosed air reservoir according to an embodiment of the invention.

FIG. 5B shows a side view of a liquid lens assembly with an open air reservoir according to an embodiment of the invention.

FIG. 5C shows a side view of a liquid lens assembly with an enclosed air reservoir and dome-shaped lens according to an embodiment of the invention.

FIG. 6A shows a side view of an air reservoir with curled ends, according to an embodiment of the invention.

FIG. 6B shows a side view of an air reservoir with enlarged ends, according to an embodiment of the invention.

FIG. 7A shows a side view of a liquid lens assembly with an inwardly curved cavity with a disturbed liquid lens according to an embodiment of the invention.

FIG. 7B shows a side view of a liquid lens assembly with the liquid pushed out to fill the inwardly curved cavity.

FIG. 7C shows a side view of a liquid lens assembly with the liquid pushed against the air reservoir.

FIG. 7D shows a side view of a liquid lens assembly with a retracting liquid.

FIG. 7E shows a side view of a liquid lens assembly with a re-formed liquid lens.

FIG. 8A shows a liquid lens housing with solid lens and cavities to hold liquid lenses according to an embodiment of the invention.

FIG. 8B shows a liquid lens and solid lens according to an embodiment of the invention.

FIG. 8C shows a liquid lens and a solid plano convex lens according to an embodiment of the invention.

FIG. 8D shows two liquid lenses and two solid lenses according to an embodiment of the invention.

FIG. 8E shows two liquid lenses and one solid lens sandwiched in between according to an embodiment of the invention.

FIG. 9 shows a single pump actuation method according to an embodiment of the invention.

FIG. 10 shows an actuation method according to another embodiment of the invention.

FIG. 11 shows an actuation method according to another embodiment of the invention.

FIG. 12 shows a more detailed drawing of the embodiment of FIG. 11.

FIG. 13 shows a block diagram for a liquid lens control system according to another embodiment of the invention.

FIG. 14 shows a single electrical motor used to actuate two liquid lenses according to another embodiment of the invention.

FIG. 15 shows a side view of a liquid lens-based, auto-focus lens system according to an embodiment of the invention.

FIG. 16 shows a side view of a liquid lens-based, auto-focus lens system according to another embodiment of the invention.

FIG. 17 shows a side view of liquid lens system with a zoom/focus module according to an embodiment of the system.

FIG. 18 shows a side view of a liquid lens system with a variable-focus and variable-diameter lens module according to an embodiment of the system.

FIG. 19 shows a side view of a liquid lens system with a zoom/focus module according to another embodiment of the invention.

FIG. 20 shows a liquid lens system with a zoom/focus module according to another embodiment of the invention.

FIG. 21 shows a piezoelectric tube actuator according to an embodiment of the invention.

FIG. 22A shows a top view of a piezoelectric disc actuator using a piezoelectric buzzer diaphragm according to an embodiment of the invention.

FIG. 22B shows a side view of the piezoelectric disc actuator.

FIG. 22C shows a top view of a piezoelectric disc actuator using a curved piezoelectric diaphragm according to an embodiment of the invention.

### DETAILED DESCRIPTION OF THE INVENTION

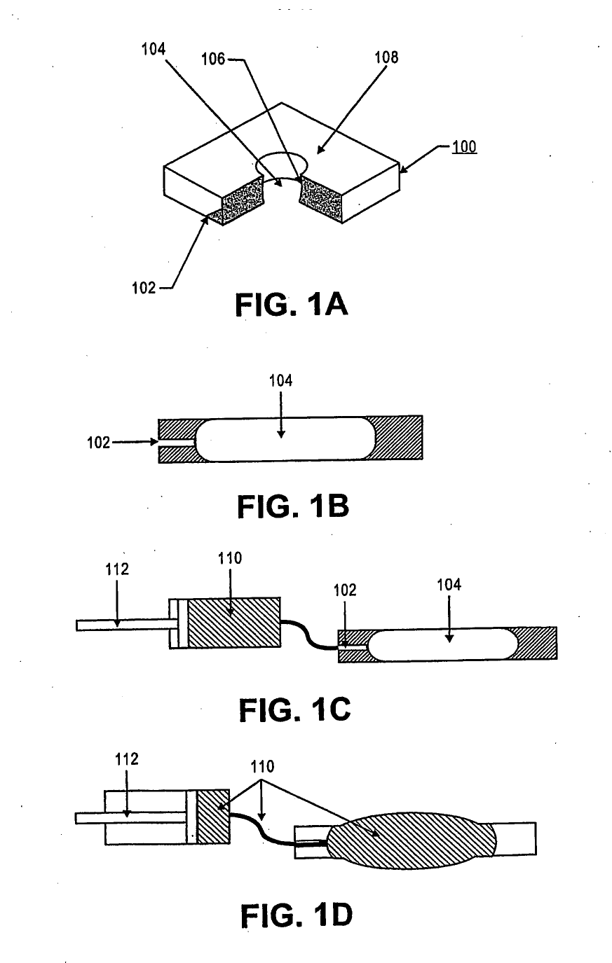

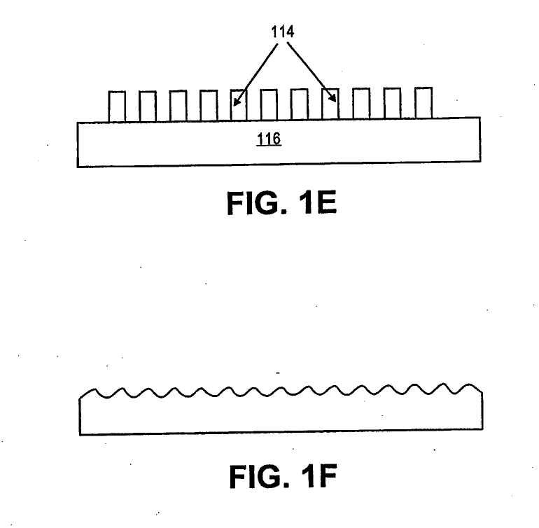

FIGS. 1A-1D show a lens assembly that holds a variable-focus liquid lens within an inwardly curved lens cavity or chamber, according to one embodiment of the invention.

FIG. 1A shows an isometric view of a liquid lens assembly 100 with a lens cavity 104 that is inwardly curved. FIG. 1B shows the side view of the same lens assembly 100. As shown, the lens cavity 104 is inwardly curved, like the shape of a barrel, to provide a region where the liquid will conglomerate due to surface tension before forming a whole lens. In FIGS. 1A-1D, this region is located at the largest perimeter within lens cavity 104, and a ring is subsequently formed on this perimeter. As more liquid enters lens cavity 104, the ring will grow and eventually develop into a liquid lens. This procedure can be further improved by an additional actuation method.

One actuation system includes a pump configured to introduce a fixed volume of liquid into lens cavity 104 to form a lens and then changes the shape of the lens by controlling the small amount of liquid. For example, FIG. 1C shows a fixed volume of liquid 110 at pump 112, before liquid 110 enters lens cavity 104 through the inlet 102. Liquid 110 may be any liquid suitable for lens formation, such as water, glycerol, etc. FIG. 1D shows liquid 110 pumped into lens cavity 104 after pump 112 is displaced to the right. Actuation enhancement elements may also be used for retracting the liquid to disable the lens, as described further below.

In one embodiment, lens cavity 104 is coated with hydrophilic coating 106, and the top and bottom surfaces of the lens assembly 100 are coated with hydrophobic coating 108. The boundary at the hydrophobic regions constrains the liquid and presents a meniscus having a curvature defined in part by the static (or dynamic) contact angle of the fluid at the boundary. The hydrophobic material may be a material such as plastic, polymers, ceramics, alloys, or a fluoropolymer such as Teflon, CYTOP or zirconium oxynitride. The hydrophilic region may be made of a material such as plastic, polymer, glass, quartz, zirconium oxynitride, or fused silica. Other suitable materials include ceramics, hydrophilic metals, hydrophilic alloys or hydrophilic polymers such as, for example, hydroxylic polyacrylate or polymethacrylate, polyacrylamides, cellulosics polymers, polyvinyl alcohols. Coatings of these materials can also be used to cover the inwardly curved walls.

Alternatively, according to another embodiment of the invention, use of a hydrophobic coating on a surface may be replaced by the use of micro- or nano-structures on the surface as shown in FIG. 1E. As shown in the figure, micro- or nano-sized pillars 114 may be formed on the top and bottom surfaces of the cavity by lithography processes or by injection molding. Or, according to another embodiment of the invention, use of a hydrophilic coating on a surface may be replaced by the use of a micro- or nano-sized ridged topolology on the surface, as shown in FIG. 1F.

The static/dynamic contact angle may be varied by applying pressure to the liquid or by pumping more liquid into the cavity, which shifts the interface across the hydrophilic-hydrophobic boundary, and thus changes the curvature and contact angle of the meniscus. For example, the static contact angle may give a concave lens. However, applying pressure to the meniscus would further push it into the hydrophobic region and change the contact angle so that the lens is convex. In this manner, the curvature of the lens formed by the fluid meniscus can be tuned. Thus, an optical device according to embodiments of the invention typically includes a pressure control means fluidly coupled with the liquid for this purpose. In general, the curvature of the meniscus will have a tunability range between the static/dynamic contact angle of the fluid with the hydrophilic surface and the static/dynamic contact angle of the fluid with the hydrophobic surface.

The pressure generating device and/or a device that alters the volume of fluid in a cavity can take a variety of forms. For example, the pressure applied to the fluid may be electrokinetic pressure generated by electro-osmosis, or pressure generated using a ratchet pump, piezoelectric diaphragm pump, piezoelectric buzzer pump, voice coil pump, piezo tube pump or by electro-wetting. In other embodiments, fluid pressure may be generated using pneumatic or magnetohydrodynamic pumps. In yet other embodiments, the pressure applied to the fluid may be generated by a mechanical device. One example of a useful mechanical pressure generating device is a screw-type pumping device or a peristaltic pump.

Inwardly Curved Cavity

The inwardly curved cavity according to embodiments of the invention ensures smooth and efficient development of the liquid lens. The liquid typically forms a droplet at inlet 102 on the left side of cavity 104 for the lens assembly of FIGS. 1A-1D. The droplet then enlarges until it covers the entire cavity.

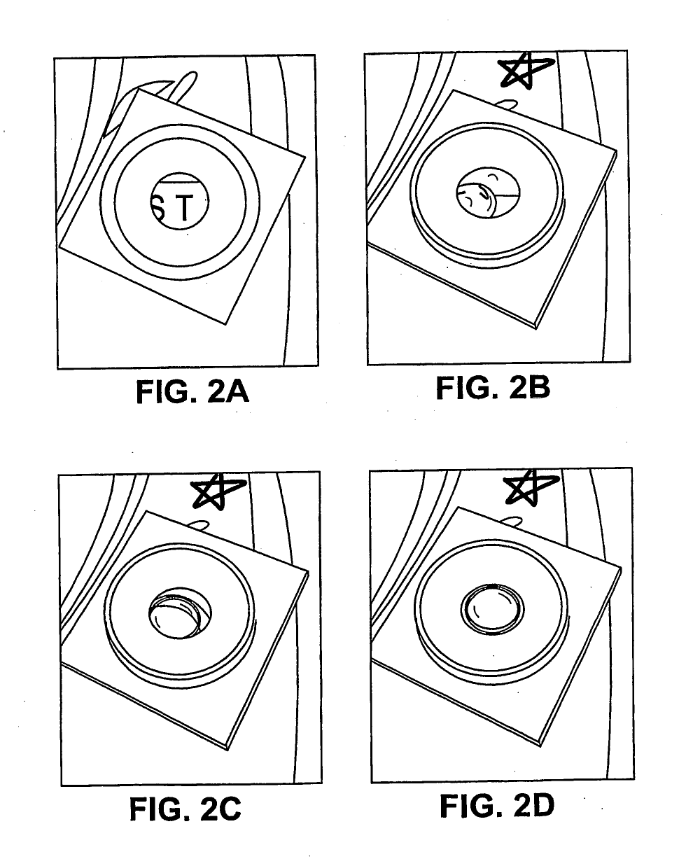

In contrast, a cavity with flat (e.g., cylindrically shaped) walls requires higher energy for the formation of a liquid lens. For example, FIGS. 2A-2D illustrate top views of such a liquid lens cavity with flat walls. FIG. 2A shows an empty lens cavity with flat walls. In FIG. 2B, the liquid starts at the inlet located at the left side of the cavity, as shown by the droplet partially covering the cavity. FIG. 2C shows the liquid droplet enlarged from the inlet FIG. 2D shows the liquid droplet enlarged to fill the entire cavity.

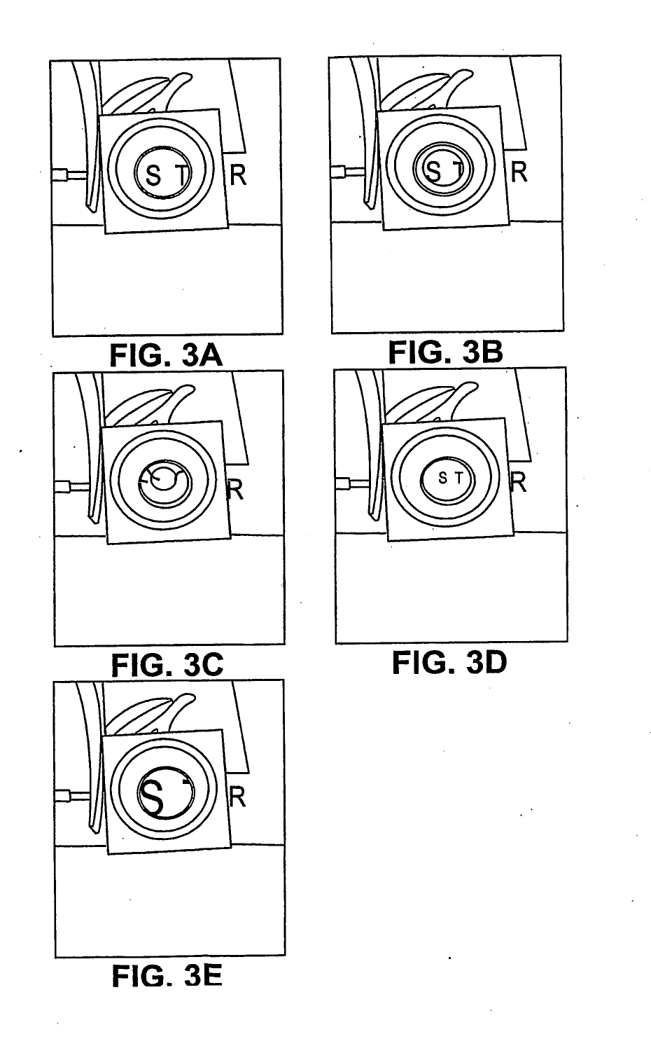

FIGS. 3A-3E show top views of a liquid lens cavity with inwardly curved (e.g., barrel shaped) walls according to one embodiment of the invention. For an inwardly curved cavity, the liquid from the inlet flows in the region with the least energy for the liquid to settle. FIG. 3A shows an inwardly curved cavity that is empty. FIG. 3B shows an inwardly curved cavity with a liquid ring formed on the largest perimeter of the cavity, as shown by the edges of the liquid droplet along the edges of the cavity's opening. FIG. 3C shows the liquid ring growing and merging inwards, as shown by the edges of the droplet converging toward the center and away from the edges of the cavity. FIG. 3D shows a top view of a concave lens formed at the cavity, as evidenced by the diminished size of the letters. Likewise, FIG. 3E shows a top view of a convex lens formed at the cavity, as evidenced by the magnified size of the letters. As described above, the concave or convex character of the liquid lens may be tuned by a pressure control mechanism or volume control mechanism coupled with the lens assembly that changes the curvature and contact angle of the meniscus lens upon application of pressure (or reduction of pressure) or volume change of the fluid in the cavity, thus changing the curvature of the meniscus.

Forming the lens first at the surface of lowest energy, as for the largest perimeter of the inwardly curved cavity, enhances the stability of the liquid lens. Accordingly, the liquid is less likely to fall or break apart from the lens cavity, and more efficiently form a well-shaped lens.

Retraction of Liquid: Disabling the Lens

According to embodiments of the invention, the liquid for the liquid lenses may be disabled or ‘turned off’ by retracting the liquid into a reservoir for storage when the lens is not in use. The procedure for retracting the liquid lens is, in certain aspects, enhanced by an additional actuation method such as by using a pump that may also be used for forming the liquid lens. In this case, the pumps for actuation may also be used as the reservoirs for storing the retracted liquid.

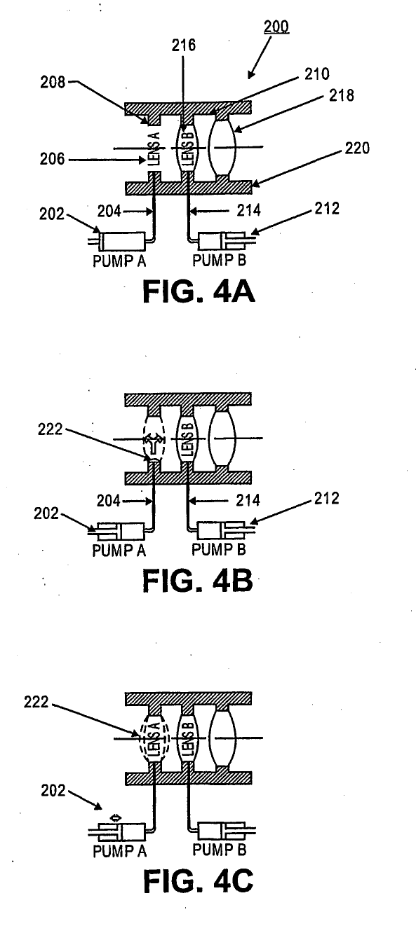

FIGS. 4A-4C show side views of a lens assembly holding multiple lenses, according to an embodiment of the invention. In FIG. 4A, lens assembly 200 has a lens housing 220 which holds liquid lens 206 (Lens A), liquid lens 216 (Lens B), and solid lens 218. Liquid lens 206 is connected to pump 202 (Pump A) through inlet 204, and liquid lens 216 is connected to pump 212 (Pump B) through inlet 214. Lens assembly 200 also includes inwardly curved cavity 208 which preferably has a hydrophilic coating covering its walls. Hydrophobic coating 210 covers the top and bottom surfaces of each lens cavity of lens assembly 200.

FIG. 4B shows a liquid 222 filling the lens cavity to form lens 206. FIG. 4B shows pump 202 is activated to the “offset” position, in which case the displaced liquid 222 is pumped out to fill the designated cavity for lens 206. Pump 202 stops when the fixed volume of liquid to form liquid lens 206 is displaced sufficiently to form the lens within the cavity. Pumps 202 and 212 are also controlled so that magnification, focusing and zooming are effected. For example, FIG. 4C shows adjustments to the shape (radius of curvature) of lens 206 using pump 202, after pumping a fixed volume of liquid 222 to form lens 206.

When lens 206 and 216 in FIGS. 4A-4C are not in use, the respective liquids can be retracted and stored inside pumps 202 and 212, respectively. Retraction to ‘turn off’ the lens is particularly useful for minimizing harmful effects of high impact and shock applications to the optical device. For example, disabling the lens when it is not in use prevents disturbances such as droplets being formed on the glass during events of high impact when the lens is not in use. This prevents additional efforts to perform a recovery or corrective process to fix the liquid lens that has been disturbed while the optical device is not in use. In addition to automatically disabling the lens, the retraction method can also be used as an automatic reset for the liquid lens.

Air Reservoir

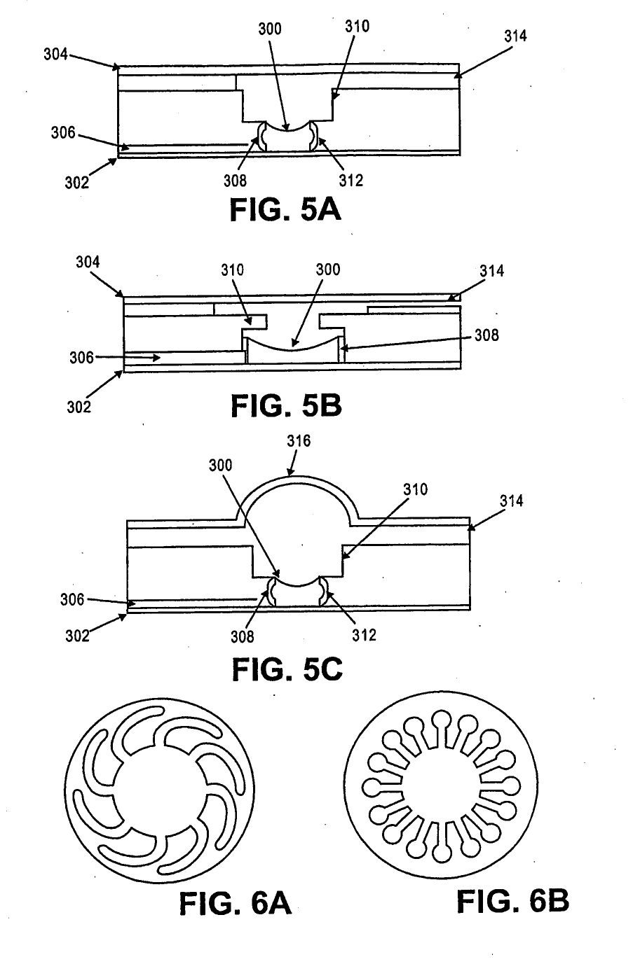

FIGS. 5A-5C show lens formation and retraction methods according to another embodiment of the invention. The lens assembly shown in FIGS. 5A-5C includes plates (e.g., glass plates) 302 and 304, a liquid channel 306, inwardly curved cavity 312 with preferably hydrophilic walls 308 (e.g., formed of a hydrophilic material or coated with a hydrophilic material), and a hydrophobic top surface of the cavity (e.g., top surface formed of a hydrophobic material or coated with a hydrophobic material). During liquid retraction, a lens may be formed or a disturbed lens may be reformed. During the process, in one aspect, the liquid fills inner cavity 312 and has complete contact with the top glass layer 304. A fluid displacing mechanism (not shown) such as a pump coupled with fluid channel 306 then retracts the liquid back until the liquid forms or reforms the lens 300.

The lens assembly according to this embodiment also includes an air reservoir 314. The air reservoir 314 can be “open” to the atmosphere or “enclosed.” In an enclosed air reservoir, the air may be trapped and compressed when the liquid fills cavity 312. FIGS. 5A and 5C show examples of enclosed air reservoirs, and FIG. 5B shows an example of an open air reservoir. In FIG. 5C, plate 304 is configured with a dome cover 316, which operates as a wide-angle lens. For example, plate 304 may itself be shaped to form the dome cover, or a separate dome cover may overlay plate 304.

Air reservoir 314 is used to guide the liquid into and out of the liquid channels, and thus facilitates smooth recovery or reformation of the lens. Air is compressed in the air reservoir, and upon retraction of the liquid the compressed air assists in guiding the excess liquid back into inner cavity 312. Air reservoir 314 can also be comprised of more than one channel, with the channel or channels designed to allow the compression of air.

FIGS. 6A and 6B show top views of two possible designs for air reservoirs. The air reservoirs shown are circular but may be non-circular as well. The spiral design shown at FIG. 6A provides ends that are curled to provide extra surface area per channel within the circle. The design shown at FIG. 6B provides ends that are enlarged at their ends to allow more air for compression.

Retraction of Liquid: Recovering the Lens

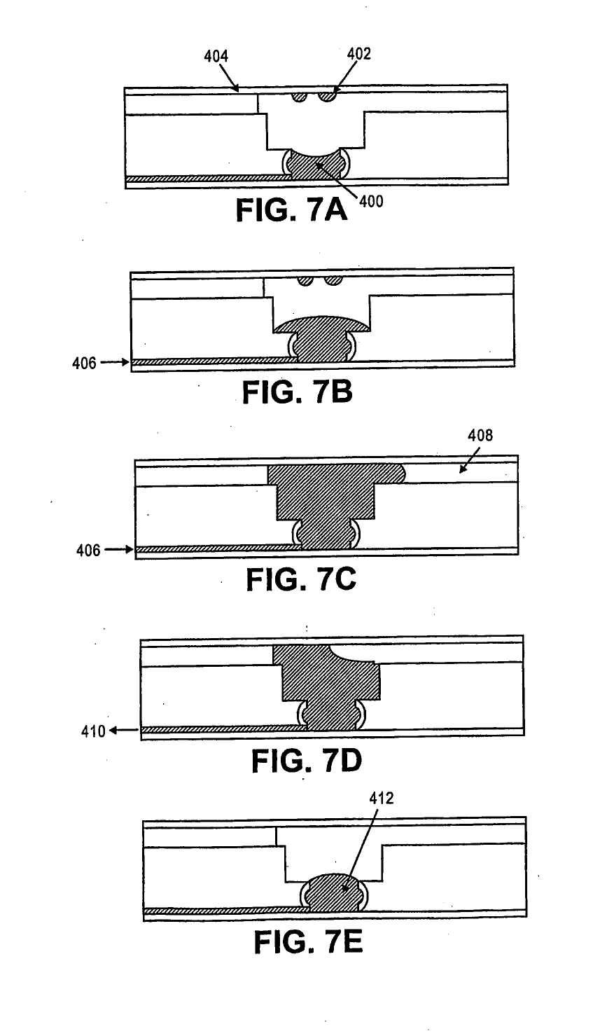

FIGS. 7A-7E show the recovery process for a disturbed liquid lens in an enclosed system according to an embodiment of the invention. For example, FIG. 7A shows a liquid lens system after it has been disturbed, which has caused droplets 402 to deposit on the upper glass plate 404. In the step of FIG. 7B, a pump (not shown) pushes more liquid out, as shown at the arrow at 406, to fill inwardly curved cavity 400. The liquid completely fills cavity 400 and is pumped outward until it contacts the glass plate 404. FIG. 7C shows the liquid subsequently pushed against air reservoir 408, where the air is compressed in the reservoir. When the pump retracts the liquid back, as shown at the arrow of FIG. 7D, the air pressure pushes the liquid out of the air reservoir 408. This process clears away droplets 402 on glass plate 404 until reformed liquid lens 412 remains at the cavity, as shown in'FIG. 7E.

Multiple Lenses

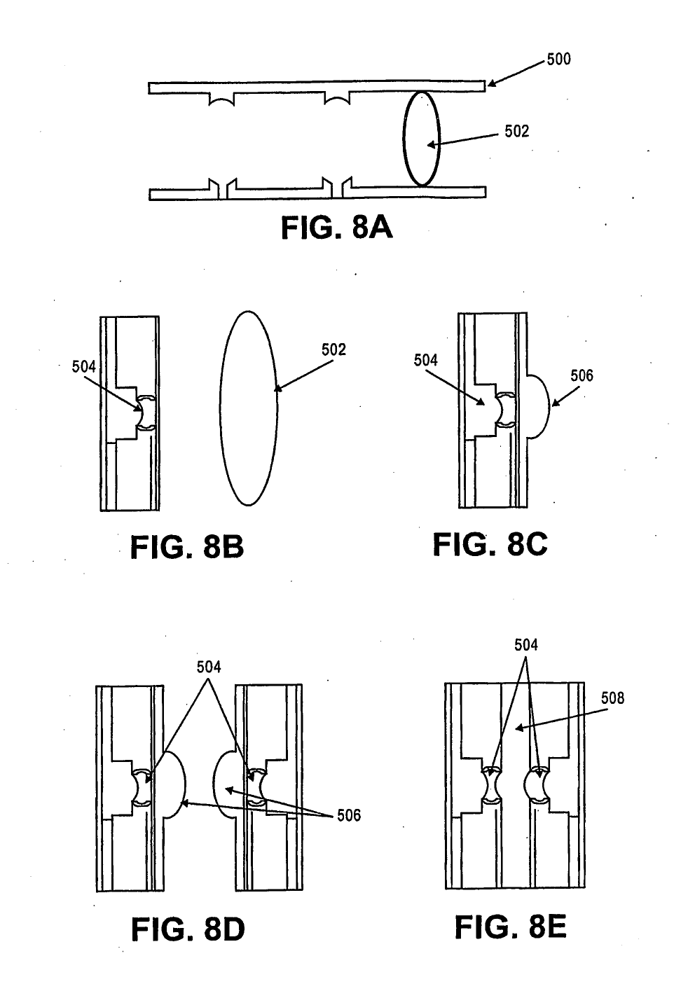

Alternative embodiments of the invention include liquid lens assemblies with several liquid lenses and/or solid lenses for focusing and zooming. FIGS. 8A-8E illustrate various possible arrangements. For example, FIG. 8A shows liquid lens housing 500 that includes solid lens 502 and cavities to hold several liquid lenses to the left of solid lens 502. FIG. 8B shows a combination including liquid lens 504 and solid lens 502. FIG. 8C shows a combination including liquid lens 504 and a solid plano convex lens 506. FIG. 8D shows a combination of two liquid lenses and two solid lenses 506. FIG. 8E shows two liquid lenses 504 and one solid lens 508 sandwiched in between. It should be appreciated that many other assembly configurations including various arrangements of solid and/or liquid lenses are possible based on the teachings herein.

Actuation Methods

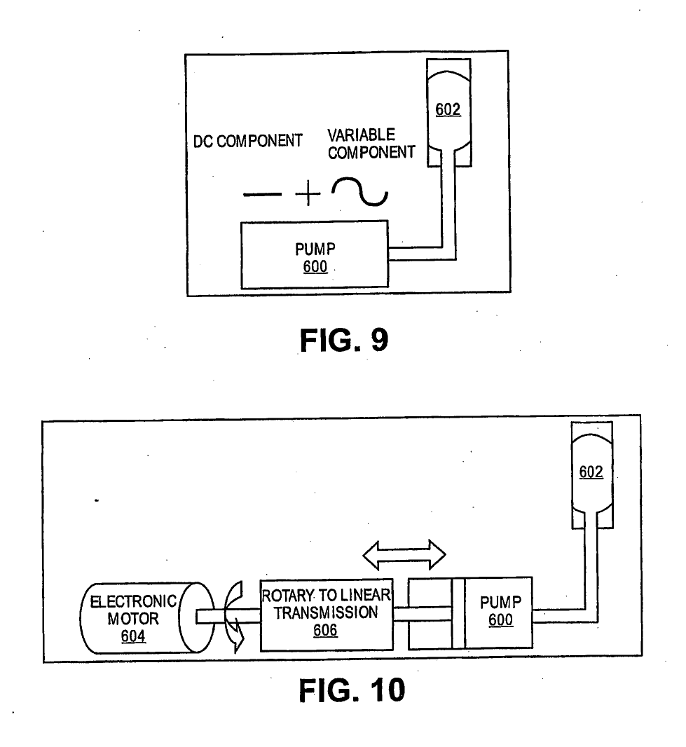

Various actuation systems and methods are useful for controlling rugged variable-focus liquid lenses with the above detailed features, according to embodiments of the invention. FIG. 9 shows a single pump actuation system according to one embodiment. The single pump 600 is actuated by applying two components of voltage signals, the offset voltage (DC component) and the variable voltage (variable component) to pump 600. In the liquid lens-forming procedure, the offset voltage is applied to pump 600 to form a liquid lens of fixed shape at the inwardly curved lens cavity 602. The variable voltage is then applied to pump 600 to change the curvature of the lens. Pump 600 can include a variety of devices, such as a piezoelectric device or a voice coil.

FIG. 10 shows an actuation system according to another embodiment of the invention. An electric motor 604 is coupled with pump 600 to turn with a designated number of rounds in order to offset a fixed volume of liquid from pump 600 into the lens chip cavity 602. The rotary motion of electric motor 604 is converted to linear motion in lens motion controller mechanism 606 (e.g., as used in handycams), which drives pump 600 as shown by the horizontal arrow. In order to control the amount of liquid for precise focusing, electric motor 604 is controlled to turn clockwise and anti-clockwise accordingly. An advantage of the system according to this embodiment is that electrical motor 604 can be deactivated once the image is focused, thus saving energy.

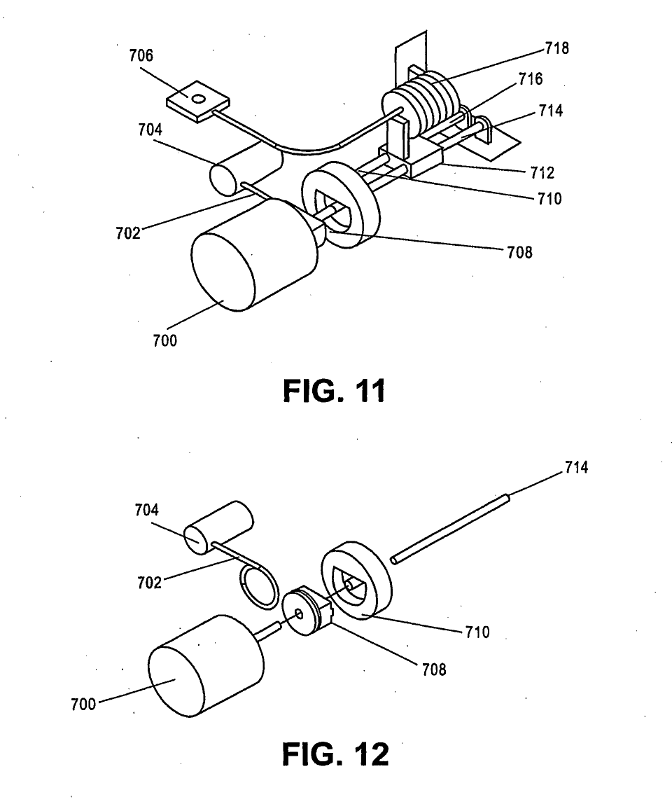

FIG. 11 shows another embodiment of the invention that is particularly suitable for mobile phone technology. The liquid lens assembly of FIG. 11 incorporates an electric motor 700 as the actuator mechanism. The liquid lens assembly of FIG. 11 also includes solenoid 704 and connecting rod 702 to balance the unbalanced weight of vibrator unit 708. The actuator system shown in FIG. 11 also includes engaging chuck 710, linear translating platform 712, fine thread stud 714, and guide rod 716.

When the liquid lens of the system of FIG. 11 is not in use (e.g., during a phone call, for a mobile phone camera), solenoid 704 is in the ‘disengage’ mode. If the liquid lens is in use, solenoid 704 is activated and pushes the vibrator unit 708 to fit into the engaging chuck 710 at the other end of the assembly. Once the engage is complete, the rotary motion of electric motor 700 is changed to linear motion for translating platform 712. The platform pushes or pulls the bellow 718, thus controlling the amount of liquid in the lens chip 706.

FIG. 12 shows a more detailed drawing of the engaging mechanism of FIG. 11. In one aspect, the engaging chuck 710 is designed such that the vibrator element 708 (e.g., unbalanced weight) fits within the chuck well and the vibration is thus eliminated or minimized. Accordingly, the engaging mechanism that eliminates the vibration of the electrical motor but maintains control of the liquid lens is a valuable contribution to various applications such as mobile phone technology.

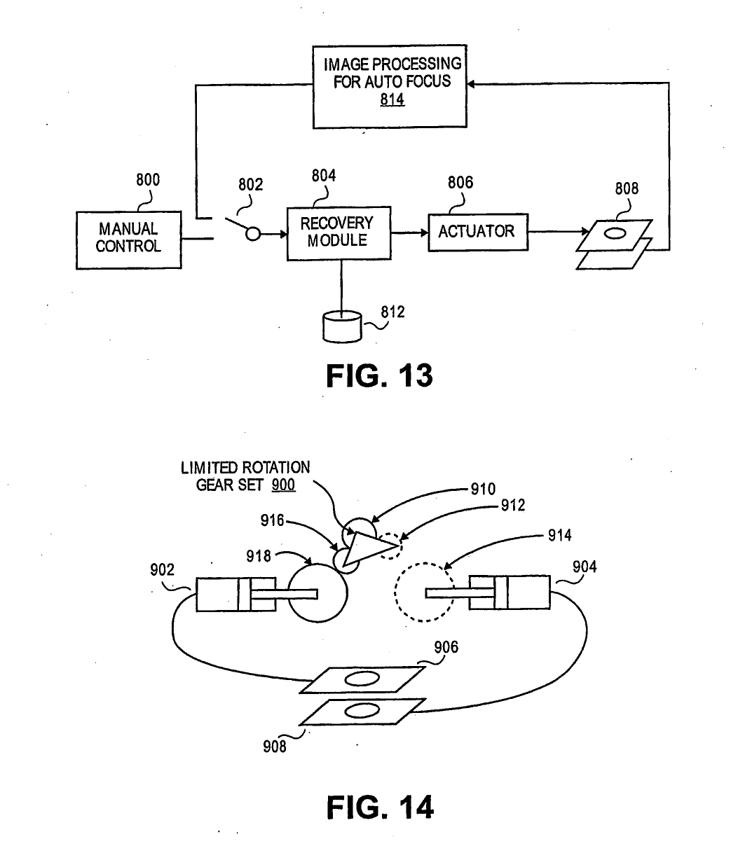

FIG. 13 shows the block diagram for a liquid lens control system according to another embodiment of the invention. In FIG. 13, the user may select either manual control or automatic control. The manual control 800 can be provided in various ways. For example, manual control 800 may be provided by two buttons for pumping in or out the liquid. Alternatively, manual control 800 may be provided by a dial or wheel that changes an electrical resistance as the dial or wheel is turned. The electrical resistance in turn controls the inflow and outflow of liquid.

In one embodiment, the recovery module 804 shown in FIG. 13 is configured to automatically reform the liquid lens if there is any shock-related accident. The automatic triggering of recovery module 804 is done by a sensor 812, which can be an accelerometer, a fall sensor or an image processing algorithm that detects blur and focused zones in an image. The actuator module 806 pumps the liquid as required to the lens chip 808 and creates an image onto the CCD chip 810. The image obtained will be processed for display and if the auto-focus module 814 is operational, connected by two-way switch 802, it will generate a compensation signal to adjust the focus (e.g., radius of curvature of the meniscus).

According to another embodiment of the invention, a single electrical motor may be used to actuate two (or more) liquid lenses, as shown in FIG. 14. In this embodiment, an electrical motor is connected to, and turns, multiple gears that actuate different lenses. For example, in FIG. 14, such a motor (not shown) is connected to gear set 900, which automatically connects it to gear 910, gear 912 and gear 916. In one aspect, gear set 900 is designed such that it has limited rotation, or in other words engages either gear 914 or gear 918 at any given time. For example, FIG. 14 shows the moment at which limited rotation gear set 900 is engaged to gear 918. Gear 918 is coupled to pump 902, which injects liquid into the lens chip 906. Once the actuation for the liquid lens at 906 is completed, gear set 900 will then engage gear 914 to actuate pump 904 and inject form a liquid lens at the lens chip 908. The limited rotation can be actuated by a solenoid (not shown).

Zoom/Focus Modules for Liquid Lens Systems

The embodiments below describe various zoom/focus modules for liquid-based lens systems. The lens systems include various combinations of solid and liquid lenses, depending on the application.

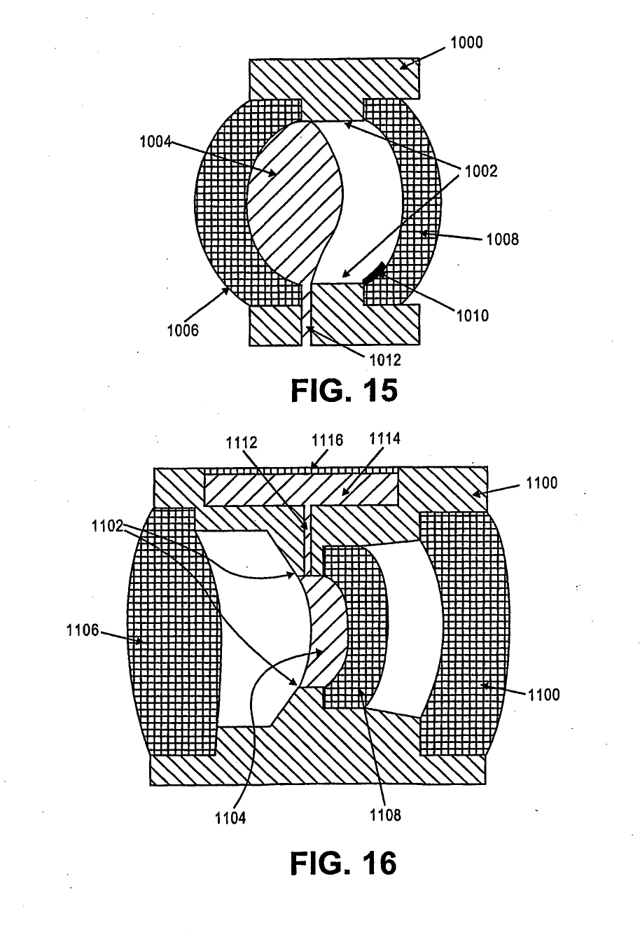

FIG. 15 shows a side view of a liquid lens system with an auto-focus module according to an embodiment of the invention. Housing 1000 holds a variable-focus liquid lens 1004 between a first solid lens 1006 and a second solid lens 1008. Housing 1000 includes hydrophobic surface 1002 and channel 1012 for filling the cavity and controlling the optics (e.g., meniscus) of the liquid lens. For the auto-focus system in the embodiment, apertures 1010 are also formed (e.g., printed) on the second solid lens.

FIG. 16 shows a side view of a liquid lens system with an auto-focus module according to another embodiment of the invention. Like the embodiment shown in FIG. 15, housing 1100 holds a variable-focus liquid lens 1104, a first solid lens 1106 and a second solid lens 1108, but additionally holds a third solid lens 1110. Housing 1100 also includes hydrophobic surfaces 1102. The liquid lens 1104 fills the cavity through channel 1112 from liquid reservoir 1114, which is coupled with an actuating means or pump 1116.

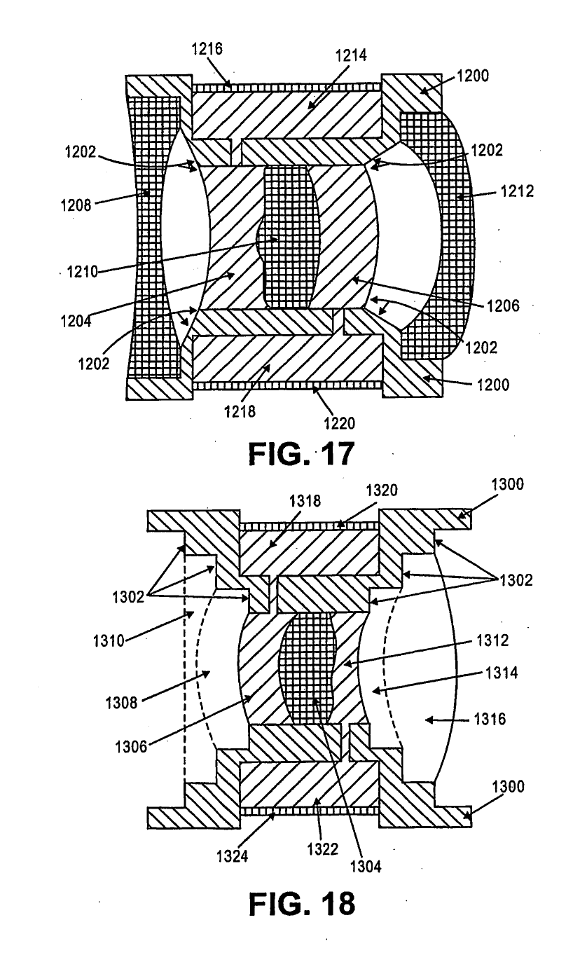

FIG. 17 shows a side view of liquid lens system with a zoom/focus module according to an embodiment of the invention. Like the embodiment of FIG. 16, housing 1200, which has hydrophobic surfaces 1202, holds a first solid lens 1208, a second solid lens 1210, a third solid lens 1212, and a first variable-focus liquid lens 1204. But housing 1200 additionally holds a second variable-focus liquid lens 1206. The first liquid lens 1204 fills a first cavity from a first liquid reservoir 1214, which is coupled with actuator or pump 1216. The second liquid lens 1206 fills a second cavity from a second liquid reservoir 1218, which is coupled with actuator or pump 1220.

FIG. 18 shows a side view of a liquid lens system with a variable-focus and variable-diameter module according to an embodiment of the invention. Housing 1300, which has hydrophobic surfaces 1302, holds a solid lens 1304, a first liquid lens 1306 and a second liquid lens 1312. First liquid lens 1306 fills a first cavity from liquid reservoir 1318, which is coupled with actuator or pump 1320. Second liquid lens 1312 fills a second cavity from liquid reservoir 1322, which is coupled with actuator or pump 1324. Housing 1300 in this embodiment is stepped so that the diameter of the liquid lens may be increased when more liquid is pumped into the cavity. For example, liquid lens 1306 may be increased in diameter to the enlarged liquid lens shown at 1308, which may be further increased in size to the enlarged liquid lens shown at 1310. Likewise, the second liquid lens 1312 may be increased in diameter to form the enlarged liquid lens 1314, and further increased to form the enlarged liquid lens 1316.

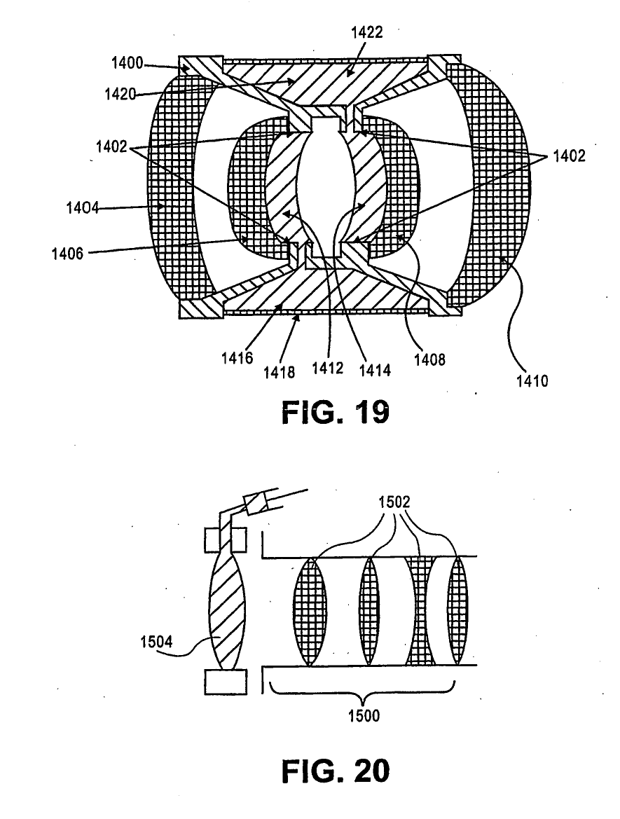

FIG. 19 shows a side view of a liquid lens system with a zoom/focus module according to another embodiment of the invention. Housing 1400, which has hydrophobic surfaces 1402, holds a first solid lens 1404, a second solid lens 1406, a third solid lens 1408, and a fourth solid lens 1410. Housing 1400 also holds a first variable-focus liquid lens 1412 and a second variable-focus liquid lens 1414. First liquid lens 1412 fills a first cavity from a first liquid reservoir 1416, which is coupled with actuator or pump 1418. Second liquid lens 1414 fills a second cavity from a second liquid reservoir 1420, which is coupled with actuator or pump 1422.

FIG. 20 shows a liquid lens system with a zoom/focus module according to another embodiment of the invention. In this embodiment, a retractable variable-focus liquid lens 1504 is placed proximal to a fixed focus camera lens module 1500 that includes solid lens assembly 1502 to achieve the zoom/focus functions. The retractable liquid lens 1504 may be used for selectively focusing objects in close proximity to the camera. However, when close proximity focusing is not required, liquid lens 1504 may be completely disabled by retracting all of the liquid back into its reservoir. Fixed focus module 1500 may then employ only the solid lenses in lens assembly 1502 for fixed focusing.

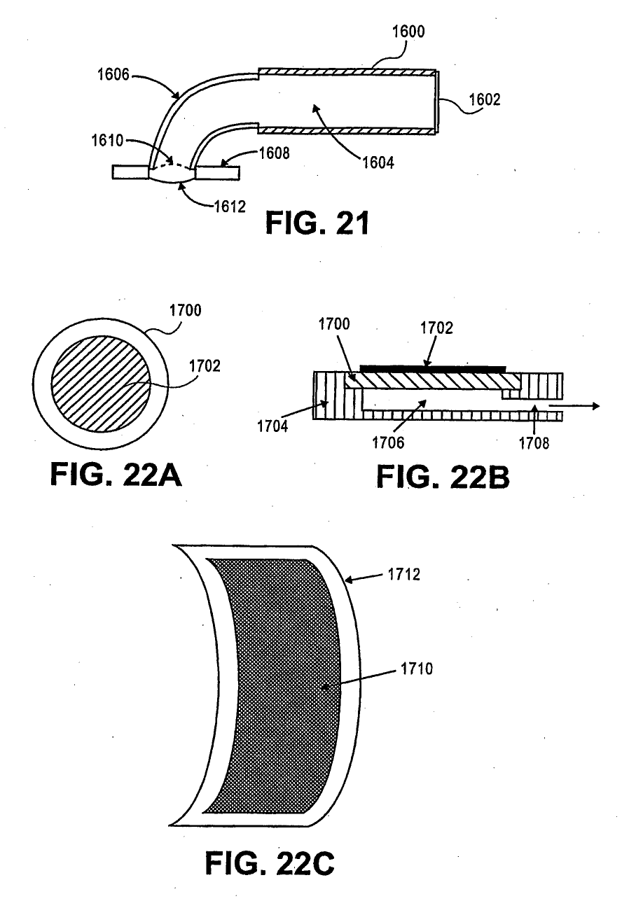

FIG. 21 shows a piezoelectric tube actuator according to an embodiment of the invention. The piezoelectric tube 1600 has a closed bottom 1602 and is filled with liquid 1604. The tube 1600 connects via connector 1606 to a liquid lens chip 1608. The piezoelectric tube 1600 operates as an actuator by contracting or expanding when a voltage is applied, which reduces or increases the volume of space inside the tube. As a result, excess liquid volume 1604 is pumped out of or into tube 1600 to form a liquid lens at the tube's outlet. As shown in the figure, the liquid meniscus at 1610 may be curved inward within the connecting portion 1606 before any voltage is applied. After a voltage is applied, the liquid meniscus may then be pushed out of connecting portion 1606, as shown at 1612.

FIGS. 22A-22B show a piezoelectric disc actuator using a piezoelectric buzzer diaphragm, according to an embodiment of the invention. FIG. 22A shows a top view of a piezoelectric buzzer diaphragm, which includes a metallic diaphragm 1700 and piezoelectric layer 1702. FIG. 22B shows a cross sectional view of the piezoelectric buzzer diaphragm, including diaphragm 1700 and piezoelectric layer 1702, mounted on housing 1704 of a liquid lens system. The diaphragm 1700 operates to pump liquid 1706 out of channel 1708 to form a liquid lens. FIG. 22C shows a variation to the embodiment of FIGS. 22A-22B, and includes a piezoelectric layer 1710 and curved metallic diaphragm 1712. Instead of being placed on top of the lens housing as for the disc embodiment of FIGS. 22A-22B, the curved piezoelectric diaphragm is mounted around the lens housing:

While the invention has been described by way of example and in terms of the specific embodiments, it is to be understood that the invention is not limited to the disclosed embodiments. To the contrary, it is intended to cover various modifications and similar arrangements as would be apparent to those skilled in the art. For example, various possible arrangements of lens assemblies with variable focus capability of the liquid lenses exist and the embodiments are not limited to the ones described herein. Therefore, the scope of the appended claims should be accorded the broadest interpretation so as to encompass all such modifications and similar arrangements.

What is claimed is:

1. An optical device comprising:
a housing having a top hydrophobic surface, a bottom surface and a first cavity, wherein the cavity has inwardly curved walls;
a first fluid having a meniscus disposed within the first cavity; and
a first control means coupled with the first fluid for displacing fluid into and out of the first cavity.

2. The device of claim 1 wherein the hydrophobic top surface includes a layer of hydrophobic material covering a non-hydrophobic material.

3. The device of claim 1 wherein the walls are hydrophilic or include a layer of hydrophilic material covering a non-hydrophilic material.

4. The device of claim 1 wherein the hydrophobic top surface includes micro- or nano-sized pillars formed on the surface.

5. The device of claim 1 wherein the hydrophobic top surface includes a micro- or nano-sized ridged topology.

6. The device of claim 1 wherein the control means includes a pump for adjusting the curvature of the meniscus.

7. The device of claim 1 wherein the control means includes a pump configured to displace a fixed volume of liquid into the cavity.

8. The device of claim 1 wherein the control means includes a pump for retracting the fluid into a reservoir.

9. The device of claim 1 further comprising an electric motor coupled with the control means.

10. The device of claim 2 wherein the hydrophobic material includes a material selected from the group consisting of Teflon, CYTOP, zirconium oxynitride, polymers, ceramics, alloys or any other hydrophobic materials.

11. The device of claim 3 wherein the hydrophilic material includes a material selected from the group consisting of glass, fused silica, ceramic, hydrophilic metal, hydrophilic polymer materials, hydrophilic alloys, or any other hydrophilic materials.

12. The device of claim 1 further comprising an air or gas reservoir with compressed air or gas.

13. The device of claim 1 wherein the first fluid can form a concave or convex lens.

14. The device of claim 1 further comprising:
a second cavity;
a second fluid having a meniscus disposed within the second cavity;
a second control means coupled with the second fluid for displacing fluid into the second cavity.

15. The device of claim 14, wherein the first and second control means are coupled with a single motor.

16. The device of claim 1 wherein the housing comprises multiple lenses, including at least one solid plano convex lens.

17. The device of claim 1 wherein the housing comprises multiple lenses, including at least one solid lens.

18. An optical device comprising:
a housing having a top surface, a bottom surface, and a cavity;
an air reservoir for holding compressed air;
a fluid having a meniscus disposed within the cavity;
a layer of hydrophobic material covering the top surface;
a layer of hydrophilic material covering the walls of the cavity; and
a control means coupled with the fluid for displacing fluid into and out of the cavity.

19. The device of claim 18 wherein the cavity has inwardly curved walls.

20. The device of claim 18 wherein the control means includes a pump configured to push fluid against the air reservoir.

21. The device of claim 18 wherein the control means includes a pump configured to retract fluid into a fluid reservoir.

22. The device of claim 18 wherein the air reservoir comprises more than one channel.

23. The device of claim 18 wherein the air reservoir has a circular or non-circular cross section and a plurality of openings spiraling out from the center.

24. The device of claim 18 wherein the air reservoir has a circular or non-circular cross section and a plurality of openings with enlarged ends extending out from a center.

25. The device of claim 18 wherein the air reservoir is open to the atmosphere.

26. The device of claim 18 wherein the air reservoir is enclosed from the atmosphere.

27. The device of claim 18 wherein the top surface includes a dome shaped portion disposed proximal the cavity.

28. The device of claim 18 further comprising a solenoid configured to disengage when the device is not in use.

29. The device of claim 18 further comprising a solenoid, a vibrating element and an engaging chuck, wherein the solenoid is configured to push the vibrating element into the engaging chuck when the device is in use.

30. The device of claim 18 wherein the control means includes manually controllable buttons.

31. The device of claim 18 wherein the control means includes a manually adjustable slider, wheel or dial.

32. The device of claim 18 further comprising a sensor that triggers a recovery module when the optical device is disturbed.

33. The device of claim 18 wherein the control means includes elements that induce a rotary motion and translate the rotary motion into a linear motion that causes fluid to be displaced into the cavity.

34. The device of claim 18 wherein the control means includes a piezoelectric tube that contracts to reduce the volume inside the tube when a voltage is applied.

35. The device of claim 18 wherein the control means includes a piezoelectric layer coupled with a curved or disc-shaped metallic diaphragm.

36. A method of forming a liquid lens comprising:
providing a fluid within a housing that includes a top surface, a bottom surface, and a cavity having inwardly curved walls,
wherein the fluid forms a meniscus disposed within the cavity, wherein a hydrophobic coating covers the top surface; and
adjusting the curvature of the meniscus.

37. The method of claim 36 wherein a hydrophilic coating covers the inwardly curved walls.

38. The method of claim 36 wherein the liquid lens is formed as a ring along the walls of the cavity.

39. The method of claim 36 wherein the liquid lens is formed as a ring along the walls of the cavity, and the ring grows by converging toward the center of the cavity.

40. The method of claim 36 wherein the liquid lens first forms as a ring along a portion of the walls of the cavity having the lowest surface energy.

41. The method of claim 36 wherein adjusting the curvature of the meniscus includes applying pressure to the fluid such that the meniscus forms a concave lens.

42. The method of claim 36 wherein adjusting the curvature of the meniscus includes applying pressure to the fluid such that the meniscus forms a convex lens.

43. The method of claim 36 wherein providing a fluid includes displacing a fixed volume of fluid into the cavity.

44. The method of claim 36 further comprising providing additional fluid within the housing after a shock-related event and retracting the fluid from the cavity to reform the lens.

45. A method of retracting a fluid from a liquid lens comprising:
providing a fluid within a housing that includes a top surface, a bottom surface, and a cavity having inwardly curved walls,
wherein the fluid forms a meniscus disposed within the cavity, wherein a hydrophobic coating covers the top surface; and
retracting the fluid from the cavity.

46. The method of claim 45 wherein a hydrophilic coating covers the inwardly curved walls.

47. The method of claim 45 wherein retracting the fluid disables the lens.

48. The method of claim 45 wherein retracting the fluid resets the lens.

49. The method of claim 45 wherein retracting the fluid re-forms a lens that has been disturbed.

50. The method of claim 45 wherein retracting the fluid clears away droplets formed on an inner side of a cover over the top surface.

51. The method of claim 45 wherein providing the fluid stops after a fixed volume of fluid is displaced in the cavity.

52. The method of claim 45 further comprising providing additional fluid within the cavity so that the fluid contacts the top surface of the housing, before retracting the fluid.

53. The method of claim 45′ further comprising providing additional fluid within the cavity so that the fluid contacts an air reservoir, before retracting the fluid.

54. The method of claim 45 wherein retracting the fluid occurs when air compressed in an air reservoir within the housing pushes the fluid back.

55. The method of claim 45 wherein retracting the fluid occurs after a recovery module is triggered.

56. The method of claim 45 wherein retracting the fluid occurs in response to a manual control signal.

57. An optical device comprising:
a housing having a top surface, a bottom surface and a first cavity, wherein the cavity has inwardly curved walls;
a first fluid having a meniscus disposed within the first cavity, the first fluid forming a first liquid lens;
a first control means coupled with the first fluid for displacing fluid into and out of the first cavity; and
a first non-liquid lens.

58. The device of claim 57 further comprising a second non-liquid lens.

59. The device of claim 58 further comprising a third non-liquid lens.

60. The device of claim 57 further comprising:
a second cavity with inwardly curved walls;
a second fluid having a meniscus disposed within the second cavity, the second fluid forming a second liquid lens;
a second control means coupled with the second fluid for displacing fluid into and out of the second cavity.

61. The device of claim 60 further comprising a second non-liquid lens.

62. The device of claim 60 further comprising a third non-liquid lens.

63. The device of claim 60 further comprising a fourth non-liquid lens.

64. The device of claim 57 wherein the housing further includes walls having a stepped profile.

65. The device of claim 57 wherein the liquid lens provides for focusing or zooming functions and the non-liquid lens compensates for negative effects of the fluid lens.

66. The device of claim 57 wherein the control means is configured to change the zoom or focus type of the optical device by displacing the fluid into or out of the cavity.
